(19) United States
(12) Patent Application Publication
(10) Pub. No.: US 2011/0017029 A1
(43) Pub. Date: Jan. 27, 2011

(54) Hand Tool

(76) Inventor: Tsai-Ching Chen, Fu Hsing Shiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/714,748

(22) Filed: Mar. 1, 2010

(30) Foreign Application Priority Data
Jul. 27, 2009 (TW) 98125221

(51) Int. Cl. B25B 23/00

(52) U.S. Cl. 81/177.75

(57) ABSTRACT

A hand tool comprises a shaft including a first coupled portion; a double-ended joint including a second coupled portion coupled to the first coupled portion and a third coupled portion; wherein the double-ended joint is pivotable with respect to the shaft between first and second positions; an interconnecting member including a fourth coupled portion coupled to the third coupled portion and a mounted portion; and wherein the interconnecting member is pivotable with respect to the double-ended joint between first and second position.

### BACKGROUND OF THE INVENTION

1. Field of the Invention

The present invention relates to a hand tool, more particularly, to a hand tool which can be bent to form various shapes so that user can use it in tiny space easily.

2. Description of the Related Art

Referring to Taiwan patent No. M305735, it discloses that a chuck includes a shaft having a hole and a magnetic element and a sleeve mounted on the shaft. The hole of the shaft is adapted to couple to a bit and the magnetic is engaged with an end of the sleeve. The shaft is slideably disposed in another end of the sleeve between a first position and a second position so that the bit can be released/installed from/to the shaft quickly.

The chuck is adapted to couple to the bit which is connected to a bolt or a driven means. A center axis of the bit and a center axis of the chuck are co-linear. However, the conventional chuck can not be bent to form various shapes and insert into a tiny space with angles neither. For example, an engine room of a vehicle, most of bolts and fasteners are disposed inside of the engine room would be hided by the other components and cannot be easily to be driven by the conventional hand tool (like the above chuck).

Moreover, in order to drive bolts hided insides of equipment, a cable-type joint is provided and can be bent to form various shapes for needs. The joint which is defined at an end of the cable is inserted into a gap between components of the equipment and engaged with the bolt. And then, rotating the cable to drive the joint to engage with/disengage from the bolt. The cable is easy to be bent; however, it cannot provide enough torque for firmly locking the bolt in a screw by the joint. Therefore, this kind of cable-type joint only applies to bolts with lightweight but not fasteners which are provided at heavy machine.

### SUMMARY OF THE INVENTION

According to the present invention, a hand tool includes a shaft, a double-ended joint, an interconnecting member for coupling to a bit and a sliding sleeve.

One objective of the present invention is that the hand tool allows the bit which is coupled thereto to insert into more tiny space in use.

Another objective of the present invention is that two ends of the double-ended joint are adapted to couple to the sliding sleeve and the shaft respectively so that the sliding sleeve and the shaft can bent with respect to the double-ended joint respectively and it provides the hand tool to have more kinds of angled shapes.

Other objectives, advantages, and features of the invention will become more apparent from the following detailed description when taken in conjunction with the accompanying drawings.

### BRIEF DESCRIPTION OF THE DRAWINGS

The present invention will be described via detailed illustration of the two embodiments referring to the drawings.

FIG. 1 is a partial, perspective view of a hand tool according to the first embodiment of the present invention.

FIG. 2 is an exploded perspective view of the hand tool as shown in FIG. 1.

FIG. 3 is a cross-sectional view taken along line 3-3 in FIG. 1.

FIG. 4 is a cross-sectional view of the hand tool as shown in FIG. 1, illustrating that the bit which is disposed inside of the hand tool is coupled to the bolt.

FIG. 5 is a cross-sectional view similar to FIG. 4, but illustrating that the bolt is detached from the magnetic element.

FIG. 6 is a cross-sectional view of the hand tool and the bit which is inserted to the hand tool.

FIG. 7 is a cross-sectional view of the hand tool and the bit as shown in FIG. 6, illustrating the double-ended joint is bent with respect to the shaft.

FIG. 8 is a cross-sectional view similar to FIG. 7, but illustrating a maximum angle which is formed by the center axes of the sliding sleeve and the shaft of the bent hand tool.

FIG. 9 is a partial, cross-sectional view of a hand tool according to the second embodiment of the present invention.

### DETAILED DESCRIPTION OF THE PREFERRED EMBODIMENT

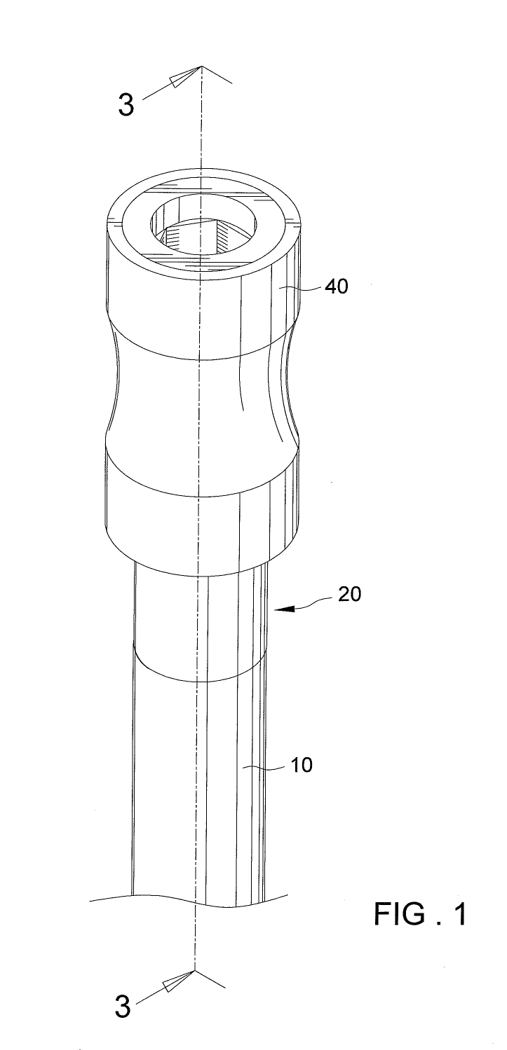

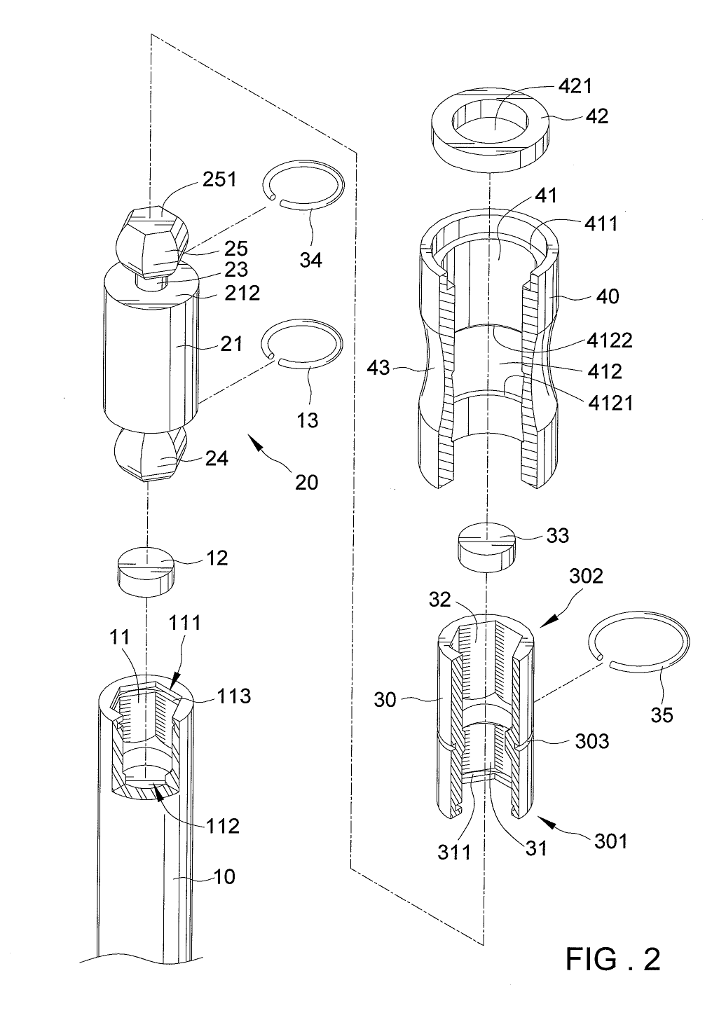

With reference to FIGS. 1 through 8, they show a hand tool in accordance with a first embodiment of the present invention. The hand tool includes a shaft 10, a double-ended joint 20, an interconnecting member 30 and a sliding sleeve 40.

The shaft 10 includes a first coupled portion 11 formed at an end thereof, a positioning element 12 and a blocked element 13. A handle or a power tool (not shown) can be coupled to another end of the shaft 10 opposite to the first coupled portion 11. Two ends of the first coupled portion 11 respectively define a free end 111 and a closed end 112. In this case, the positioning element 12 is in form of magnet and disposed at the closed end 112 of the first coupled portion 11. The first coupled portion 11 is in form of polygonal hole and forms with an annular groove 113 adjacent to the free end 111. The blocked element 13 is provided at the annular groove 113 and in form of C-clip. A center point of each transverse cross-section of the shaft 10 constitutes a central axis A.

The double-ended joint 20 includes a connecting portion 21, first and second neck portions 22, 23, and second and third coupled portions 24, 25 which are respectively provided at two ends of the double-ended joint 20. First and second abutted surfaces 211, 212 are respectively defined on two ends of the connecting portion 21 and extend outward the first and second neck portions 22, 23. The second and third coupled portions 24, 25 are respectively coupled to the first and second neck portions 22, 23 opposite to the connecting portion 21. The outer profiles of the second and third coupled portions 24, 25 correspond to the inner profile of the first coupled portion 11 and in this case, the second and third coupled portions 24, 25 are in form of sphere with polygonal corners. An end of each of second and third coupled portions 24, 25 is coupled to the related one of the first and second neck portions 22, 23 and the other end defines flat surface 241, 251.

In this case, the double-ended joint 20 is made of metal with magnet or the second and third coupled portions 24, 25 are both magnetic. A center point of each transverse cross-section of the double-ended joint 20 constitutes a central axis B.

The interconnecting member 30 has first and second ends 301, 302 and forms with a fourth coupled portion 31 and a mounted portion 32 inside thereof The fourth coupled portion 31 and the mounted portion 32 are in communication with each other and the first and second ends 301, 302 of the interconnecting member 30 and both in form of polygonal holes. A positioning element 33 is disposed between the fourth coupled portion 31 and the mounted portion 32 and in form of magnet. An annular groove 311 is formed on the inner wall of an end of the fourth coupled portion 31 opposite to the mounted portion 32. A blocked element 34 is provided at the annular groove 311 and in form of C-clip. An annular groove 303 is formed on the outer periphery of the interconnecting member 30 between the first and second ends 301, 302. A retaining element 35 is provided at the annular groove 303 and in form of C-clip. A center point of each transverse cross-section of the interconnecting member 30 constitutes a central axis C.

A through-hole 41 longitudinally pierces through two ends of the sliding sleeve 40 and a shoulder 411 is formed on the inner wall of an end of the through-hole 41. An annular magnetic element 42 is provided at the shoulder 411 and has a through-hole 421 therethrough axially. A limited slider section 412 is formed on the inner periphery of the through-hole 41 between the two ends of the sliding sleeve 40 and concave toward inside of the sliding sleeve 40. First and second held portions 4121, 4122 are respectively defined at two ends of the limited slider section 412. A concaved section 43 is formed on the outer periphery of the sliding sleeve 40 and corresponds to the limited slider section 412 so that users can hold on the concaved section 43 to operate the hand tool.

The second coupled portion 24 of the double-ended joint 20 is inserted into the first coupled portion 11 of the shaft 10. The blocked element 13 prevents the second coupled portion 24 detaching from the first coupled portion 11 automatically. And then, the second coupled portion 24 is fixed inside of the first coupled portion 11 via the positioning element 12 in a magnetic manner. Therefore, the first abutted surface 211 of the double-ended joint 20 is abutted against the distal end of the free end 111 of the shaft 10 and the second axis B of the double-ended joint 20 is co-axial with the first axis A of the shaft 10.

The third coupled portion 25 of the double-ended joint 20 is inserted into the fourth coupled portion 31 of the interconnecting member 30. The blocked element 34 prevents the third coupled portion 24 detaching from the fourth coupled portion 31 automatically. And then, the third coupled portion 25 is fixed inside of the fourth coupled portion 31 via the positioning element 33 in a magnetic manner. Therefore, the second abutted surface 212 of the double-ended joint 20 is abutted against the distal end of the first end 301 of the interconnecting member 30 and the second axis B of the double-ended joint 20 is co-axial with the third axis C of the interconnecting member 30.

The sliding sleeve 40 is mounted on the interconnecting member 30 and the distal end of the second end 302 of the interconnecting member 30 is abutted against the magnetic element 42. The retaining element 35 is restricted in the limited slider section 412 and selectively engaged with the first and second held portions 4121, 4122.

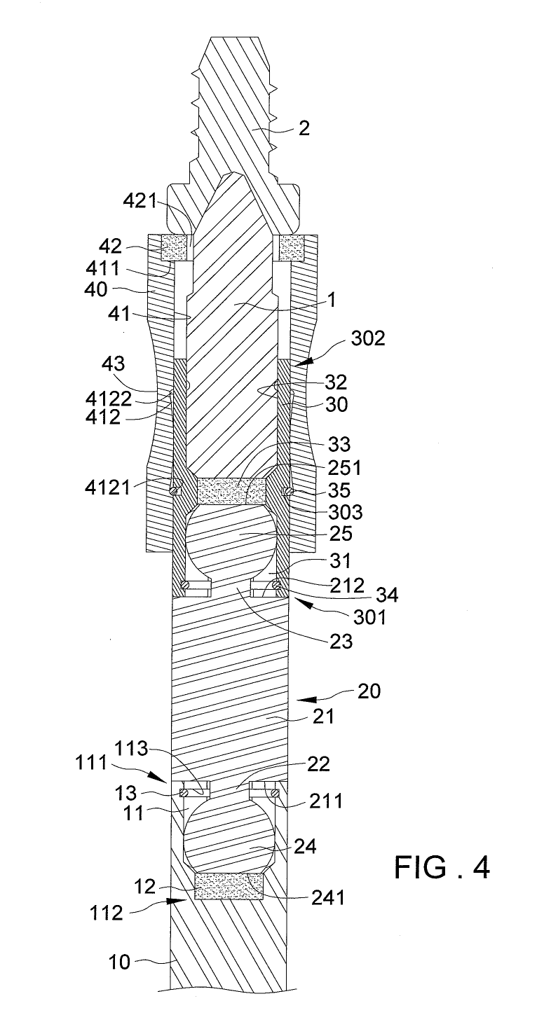

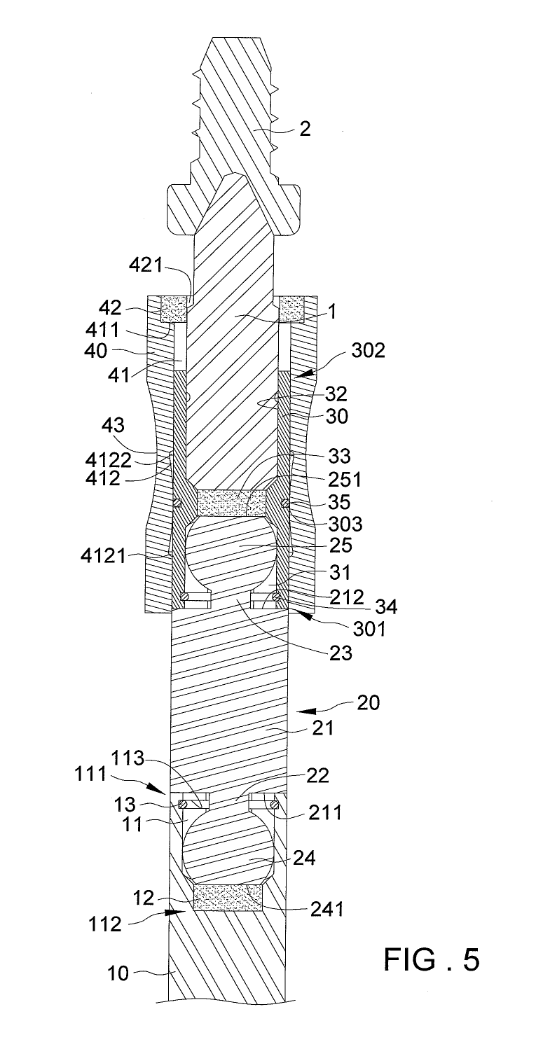

Referring to FIGS. 4 and 5, the mounted portion 32 which is defined at the second end 302 of the interconnecting member 30 is adapted to couple to a bit 1. The proximal end of the bit 1 is abutted against and fixed to the positioning element 33 in a magnetic manner. Further, a head of the bit 1 is connected to a bolt 2.

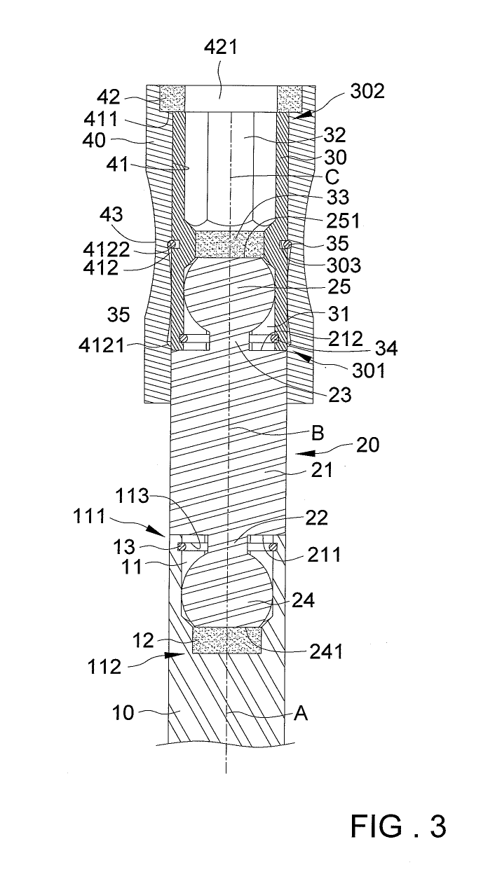

The sliding sleeve 40 is able to axially slide with respect to the interconnecting member 30 between engagement and disengagement positions while users hold on the concaved section 43 of the sliding sleeve 40 to operate the sliding sleeve 40. In the engagement position of the sliding sleeve 40, the retaining element 35 is engaged with the first held portion 4121 and then the interconnecting member 30 is away from the magnetic element 42. The head of the bit 1 is adjacent to the magnetic element 42 so that the bolt 2 which is coupled to the bit 1 is fixed to the magnetic element 42 in a magnetic manner. In the disengagement position of the sliding sleeve 40, the retaining element 35 is engaged with the second held portion 4122 (as shown in FIG. 3) and then the second end 302 of the interconnecting member 30 is abutted against the magnetic element 42. The head of the bit 1 is exposed from the sliding sleeve 40 outward.

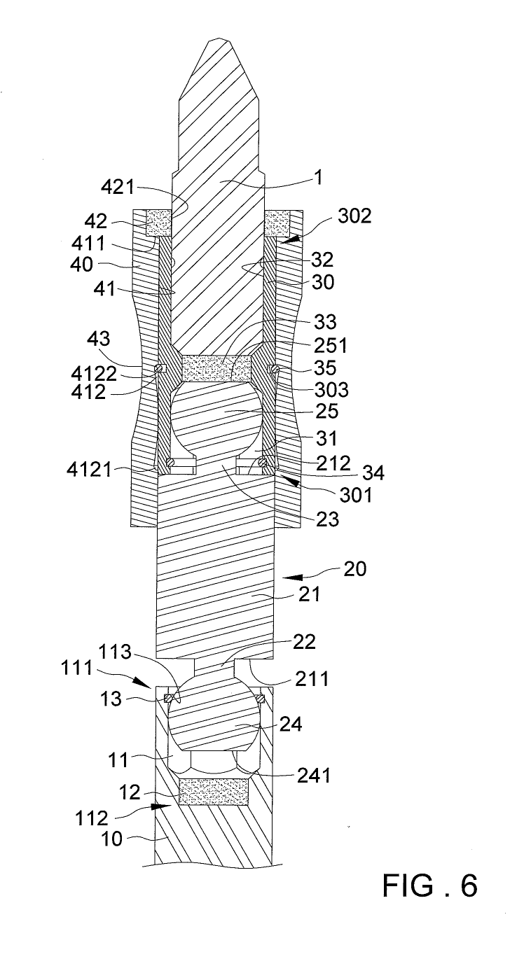

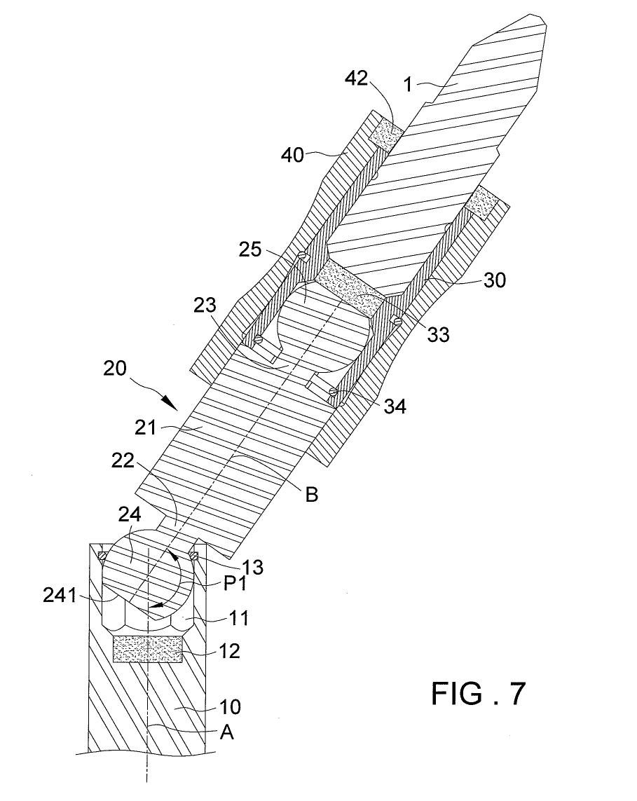

Referring to FIGS. 6 and 7, the hand tool of the present invention has to be able to be used in a tiny space and bent to form various angled shapes for needs. Hence, the double-ended joint 20 can pivot with respect to the shaft 10 between first and second positions. While the double-ended joint 20 is in the first position, the first and second axes A, B are co-axial and the second coupled portion 24 is fixed to the positioning element 12 of the shaft 10. While the double-ended joint 20 is in the second position, the first and second axes A, B form a first bent angle P1.

For operating the double-ended joint 20 to be the second position, the flat surface 241 of the double-ended joint 20 should be detached from the positioning element 12 of the shaft 10 first so that the second coupled portion 24 is not fixed to the positioning element 12 in the magnetic manner and can pivot with respect to the first coupled portion 11 of the shaft 10. And then, the distal end of the free end 111 of the first coupled portion 11 is in contact with the first neck portion 22 of the double-ended joint 20 such the first and second axes A, B intersect at the first bent angle P1.

The first bent angle P1 is changeable according to the needs of use of the environment so that the shaft 10 can be bent with respect to the double-ended joint 20 and the double-ended joint 20 can also be bent with respect to the interconnecting member 30. And it will be described below in detail.

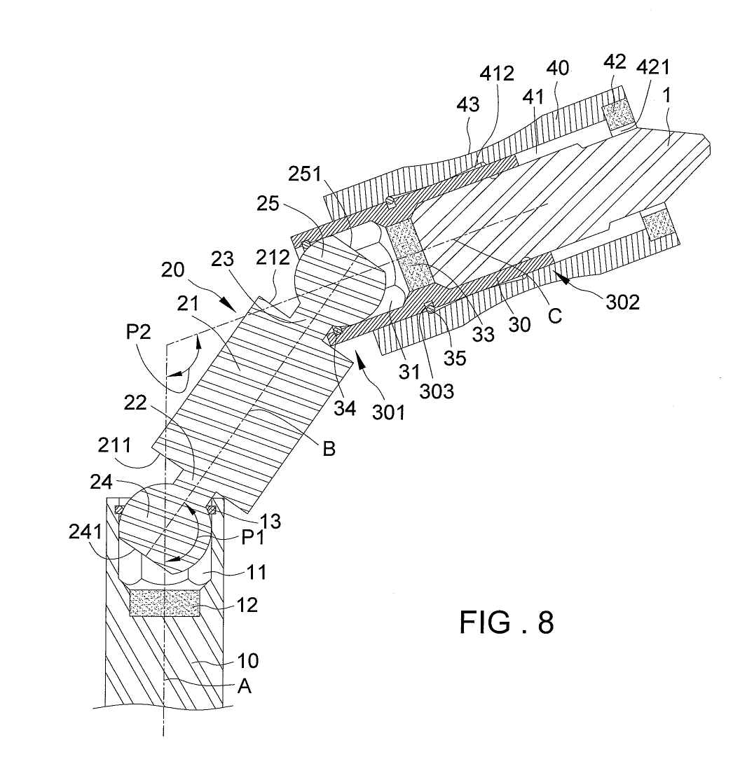

Referring to FIG. 8, it shows that the interconnecting member 30 can pivot with respect to the double-ended joint 20 and is switchable between first and second positions. While the interconnecting member 30 is in the first position, the second and third axes B, C are co-axial and the third coupled portion 25 is fixed to the positioning element 33 of the interconnecting member 30. While the double-ended joint 20 and the interconnecting member 30 are both in the second position, the first and third axes A, C form a second bent angle P2.

For operating the interconnecting member 30 to be the second position, the flat surface 251 of the double-ended joint 20 should be detached from the positioning element 33 of the interconnecting member 30 first so that the third coupled portion 25 is not fixed to the positioning element 33 in the magnetic manner and can pivot with respect to the fourth coupled portion 31 of the interconnecting member 30. And then, the distal end of the first end 301 of the interconnecting member 30 is in contact with the second neck portion 23 of the double-ended joint 20 such the first and second axes B, C intersect at an angle (not shown). Further the first and third axes A, C intersect at the second bent angle P2. The range of the second bent angle P2 is between 90 degrees and the 135 degrees. In this case, the second bent angle P2 is 110 degrees.

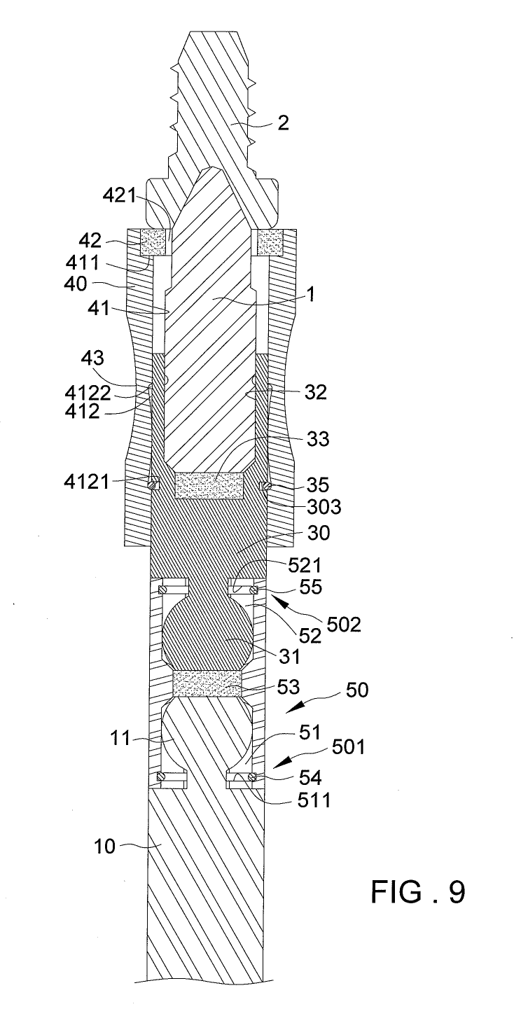

Referring to FIG. 9, it shows a hand tool in accordance with a second embodiment of the present invention similar to the first embodiment but except that a double-ended joint 50 replaces the double-ended joint 20 and the first and fourth coupled portions 11, 31 are in form of spheres with polygonal corners. The double-ended joint 50 has first and second ends 501, 502. Second and third coupled portions 51, 52 are respectively defined at the first and second ends of the double-ended joint 50 and in communication with each other. The second and third coupled portions 51, 52 are in form of polygonal holes. A positioning element 53 is provided inside of the double-ended joint 50 between the second and third coupled portions 51, 52 and in form of magnet. Annular grooves 511, 521 are defined on the inner wall of the double-ended joint 50 and respectively formed adjacent to the distal ends of the first and second ends 501, 502. Blocked elements 54, 55 are provided at the annular grooves 511, 521 respectively and in form of C-clips. The central axis B is through center points of all transverse cross-sections of the double-ended joint 50.

While several embodiments of the invention have been shown and described, it will be apparent to those skilled in the art that modifications may be made therein without departing from the scope and spirit of the present invention.

What is claimed is:

1. A hand tool comprising:
a shaft including a first coupled portion;
a first axis defined through center points of all transverse cross-sections of the shaft;
a double-ended joint including a second coupled portion coupled to the first coupled portion and a third coupled portion;
a second axis defined through center of all transverse cross-sections of the double-ended joint;
wherein the double-ended joint is pivotable with respect to the shaft between first and second positions; wherein while the double-ended joint is in the first position, the first and second axes are co-axial; wherein while the double-ended joint is in the second position, the first and second axes form a first bent angle;
an interconnecting member including a fourth coupled portion coupled to the third coupled portion and a mounted portion; and
a third axis defined through center of all transverse cross-sections of the interconnecting member;
wherein the interconnecting member is pivotable with respect to the double-ended joint between first and second position; while the interconnecting member is in the first position, the second and third axes is co-axial; while the double-ended joint and the interconnecting member are both in the second position, the first and third axes form a second bent angle.

2. The hand tool as claimed in claim 1 further comprising a sliding sleeve including a through-hole longitudinally piercing through two ends thereof and a limited slider section, which is formed on the inner periphery of the through-hole and concave toward inside of the sliding sleeve, with the limited slider section having first and second held portions respectively defined at two ends thereof; wherein the interconnecting member has first and second ends and includes a retaining element provided at the outer periphery thereof between the first and second ends of the interconnecting member, with the sliding sleeve being slideable with respect to the interconnecting member and selectively engaged with the first and second held portions.

3. The hand tool as claimed in claim 1 wherein the first and fourth coupled portions are in form of polygonal holes and the second and third coupled portions are in form of sphere with polygonal corners.

4. The hand tool as claimed in claim 3 wherein the first coupled portion has a free end and a closed end; wherein the shaft includes a positioning element disposed at the closed end of the first coupled portion; wherein the interconnecting member includes a positioning element disposed inside thereof between the fourth coupled portion and the mounted portion, with the second coupled portion being able to be fixed to the positioning element of the shaft, and with the third coupled portion being able to be fixed to the positioning element of the interconnecting member.

5. The hand tool as claimed in claim 3 wherein the shaft includes a blocked element adjacent to the closed end of the first coupled portion and preventing the second coupled portion detaching from the first coupled portion automatically.

6. The hand tool as claimed in claim 3 wherein the interconnecting member includes a blocked element at the fourth coupled portion and preventing the third coupled portion detaching from the fourth coupled portion automatically.

7. The hand tool as claimed in claim 1 wherein the double-ended joint includes a connecting portion and first and second neck portions respectively defined at two ends of the connecting portion and coupled the second and third coupled portions to the connecting portion.

8. The hand tool as claimed in claim 1 wherein the first and fourth coupled portions are in form of sphere with polygonal corners and the second and third portions are in form of polygonal holes.

9. The hand tool as claimed in claim 1 wherein range of the first bent angle is between 135 through 180 degrees and range of the second bent angle is between 90 through 135 degrees.

10. The hand tool as claimed in claim 2 further comprising a shoulder (411) formed on the inner wall of an end of the through-hole and an annular magnetic element provided at the shoulder for coupling to a bolt in a magnetic manner.

11. The hand tool as claimed in claim 2 further comprising a concaved section formed on the outer periphery of the sliding sleeve and corresponding to the limited slider section so that users can hold on the concaved section to operate the hand tool.

12. The hand tool as claimed in claim 4 wherein the positioning elements of the shaft and the interconnecting member are in form of magnet and the second and third coupled portions are magnetic and respectively coupled to the positioning elements of the shaft and the interconnecting member in the magnetic manner.

13. The hand tool as claimed in claim 1, with the mounted portion adapted for connecting to a bit.

14. The hand tool as claimed in claim 13 wherein the first and fourth coupled portions are in form of polygonal holes and the second and third coupled portions are in form of sphere with polygonal corners.

15. The hand tool as claimed in claim 14 wherein the first coupled portion has a free end and a closed end; wherein the shaft includes a positioning element disposed at the closed end of the first coupled portion; wherein the interconnecting member includes a positioning element disposed inside thereof between the fourth coupled portion and the mounted portion, with the second coupled portion being able to be fixed to the positioning element of the shaft, and with the third coupled portion being able to be fixed to the positioning element of the interconnecting member.

16. The hand tool as claimed in claim 15 wherein the positioning elements of the shaft and the interconnecting member are in form of magnet and the second and third coupled portions are magnetic and respectively coupled to the positioning elements of the shaft and the interconnecting member in the magnetic manner, with the positioning element of the interconnecting member further coupled to the bit in the magnetic manner.
